(19) United States
(12) Patent Application Publication
(10) Pub. No.: US 2009/0238283 A1
(43) Pub. Date: Sep. 24, 2009

(54) METHOD AND APPARATUS FOR ENCODING AND DECODING IMAGE

(75) Inventor: Woo-jin HAN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/405,629

(22) Filed: Mar. 17, 2009

(30) Foreign Application Priority Data
Mar. 18, 2008 (KR) 10-2008-0024872

(51) Int. Cl. H04N 7/32; H04N 7/26

(52) U.S. Cl. 375/240.16; 375/240.12; 375/E07.125; 382/238

(57) ABSTRACT

Provided are a method and apparatus for encoding an image by dividing a prediction block of a current block into a plurality of regions, thereby compensating for average values of pixel values in the prediction block by each of the plurality of the regions, and a method and apparatus for decoding the image. The method of encoding an image includes determining a first prediction block of a current block to be encoded, dividing the determined first prediction block into a plurality of regions, dividing the current block into a plurality of regions by the same number as in the divided first prediction block and calculating a difference value between an average value of pixels of each region of the first prediction block and an average value of pixels of each region of the corresponding current block, compensating each region of the divided first prediction block by using the difference value and generating a second prediction block, and encoding a difference value between the second prediction block and the current block.

### CROSS-REFERENCE TO RELATED PATENT APPLICATION

This application claims priority from Korean Patent Application No. 10-2008-0024872, filed on Mar. 18, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relates to a method and apparatus for encoding and decoding an image, and more particularly, to encoding an image by dividing a prediction block of a current block into a plurality of regions and thereby compensating for average values of pixel values in the prediction block by each of the plurality of the regions, and decoding the image.

2. Description of the Related Art

In image compression methods such as moving picture coding experts group (MPEG)-1, MPEG-2, MPEG-4, and H.264/MPEG-4 advanced video coding (AVC), a picture is divided into macro blocks to encode images. Each macro block is encoded in all the available encoding modes that can be used in inter-prediction and intra-prediction. Thereafter, one of these encoding modes is selected to encode each macro block according to a bit rate required for the macro block encoding and according to a distortion degree between a decoded macro block and an original macro block.

In intra-prediction, a prediction value of a current block to be encoded is calculated using pixel values of pixels that are partially adjacent to the current block, and a difference between the prediction value and an actual pixel value of the current block is encoded. In inter-prediction, a motion vector is generated by searching for a region that is similar to the current block to be encoded by using at least one reference picture that precedes or follows the current picture to be encoded, and a differential value, which is between a prediction block generated by motion compensation using the generated motion vector and the current block, is encoded. However, due to internal and external factors, illumination may be changed between temporally consecutive frames so that an illumination of the prediction block obtained from a reference frame and the illumination of the current block to be encoded may be different from each other. Since such an illumination change between the reference frame and the current frame has an adverse effect on the relationship between the current block and the reference block used for prediction encoding of the current block, encoding efficiency is reduced.

### SUMMARY OF THE INVENTION

The present invention provides a method and apparatus for encoding an image for dividing a prediction block of a current block into a plurality of regions, compensating for average values between the prediction block and the current block by each divided region, and reducing an illumination change between the current block and the prediction block, thereby increasing prediction efficiency of the image, and a method and apparatus for decoding the image.

According to an aspect of the present invention, there is provided a method of encoding an image, the method including: determining a first prediction block of a current block to be encoded; dividing the determined first prediction block into a plurality of regions; dividing the current block into a plurality of regions by the same number as in the divided first prediction block and calculating a difference value between an average value of pixels of each region of the first prediction block and an average value of pixels of each region of the corresponding current block; compensating each region of the divided first prediction block by using the difference value and generating a second prediction block; and encoding a difference value between the second prediction block and the current block.

According to another aspect of the present invention, there is provided an apparatus for encoding an image, the apparatus including: a prediction unit which determines a first prediction block of a current block to be encoded; a dividing unit which divides the determined first prediction block into a plurality of regions; a compensation calculation unit which divides the current block into a plurality of regions by the same number as in the divided first prediction block and calculates a difference value between an average value of pixels of each region of the first prediction block and an average value of pixels of each region of the corresponding current block; a prediction block compensation unit which compensates each region of the divided first prediction block by using the difference value and generating a second prediction block; and an encoding unit which encodes a difference value between the second prediction block and the current block.

According to another aspect of the present invention, there is provided a method of decoding an image, the method including: extracting a prediction mode of a current block to be decoded, information regarding the number of regions divided in a prediction block of the current block, and information regarding compensation values from an input bitstream; generating a first prediction block of the current block according to the extracted prediction mode; dividing the first prediction block into a plurality of regions according to the extracted information regarding the number of the regions; compensating each region of the divided first prediction block by using the extracted information regarding the compensation values and generating a second prediction block; and adding the second prediction block to a residual value included in the bitstream to decode the current block.

According to another aspect of the present invention, there is provided an apparatus for decoding an image, the apparatus including: an entropy decoding unit which extracts a prediction mode of a current block to be decoded, information regarding the number of regions divided in a prediction block of the current block, and information regarding compensation values from an input bitstream; a prediction unit which generates a first prediction block of the current block according to the extracted prediction mode; a dividing unit which divides the first prediction block into a plurality of regions according to the extracted information regarding the number of the regions; a compensation unit which compensates each region of the divided first prediction block by using the extracted information regarding the compensation values and generating a second prediction block; and an addition unit which adds the second prediction block to a residual value included in the bitstream to decode the current block.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for encoding an image, according to an exemplary embodiment of the present invention;

FIG. 2 is a reference view for explaining a dividing process performed on a prediction block, according to an exemplary embodiment of the present invention;

FIGS. 3A through 3C are reference views for explaining a dividing process performed on a prediction block, according to another exemplary embodiment of the present invention;

FIG. 4 is a reference view for explaining a process of calculating a compensation value in a compensation value calculation unit and a process of compensating each divided region of a prediction block in a prediction block compensation unit, according to an exemplary embodiment of the present invention;

FIG. 5 is a flowchart illustrating a method of encoding an image, according to an exemplary embodiment of the present invention;

FIG. 6 is a block diagram of an apparatus for decoding an image, according to an exemplary embodiment of the present invention; and

FIG. 7 is a flowchart illustrating a method of decoding an image, according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

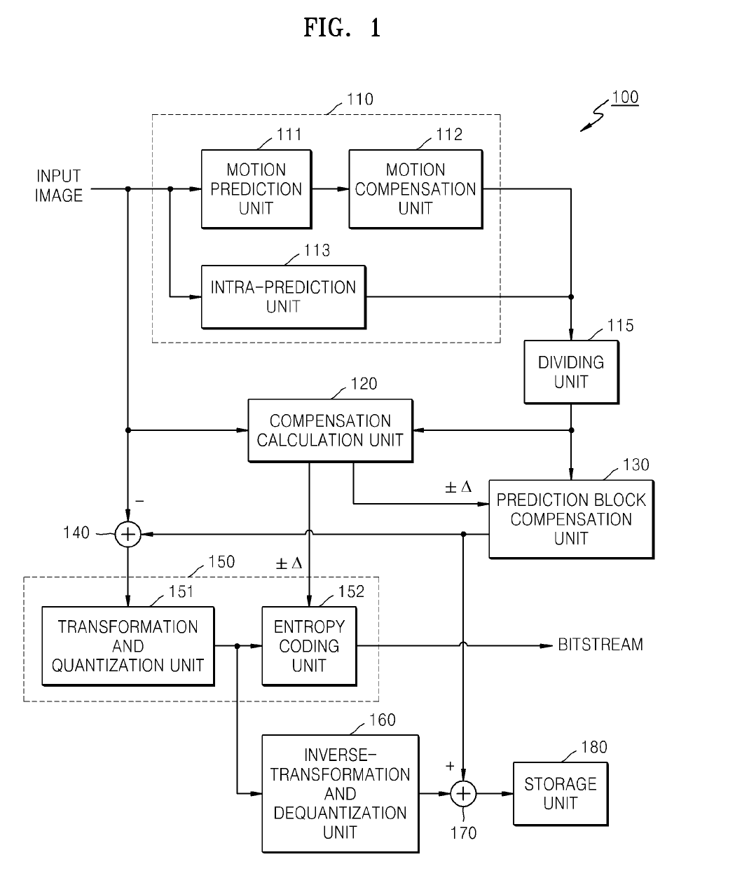

FIG. 1 is a block diagram of an apparatus for encoding an image, according to an exemplary embodiment of the present invention. Referring to FIG. 1, an apparatus 100 for encoding an image includes a prediction unit 110 comprising a motion prediction unit 111, a motion compensation unit 112, and an intra-prediction unit 113, a encoding unit 150 comprising a transformation and quantization unit 151, and an entropy coding unit 152, a dividing unit 115, a compensation calculation unit 120, a prediction block compensation unit 130, a subtraction unit 140, an inverse-transformation and dequantization unit 160, an addition unit 170, and a storage unit 180.

The prediction unit 110 divides an input image into blocks having a predetermined size and generates prediction blocks for each divided block by performing inter-prediction or intra-prediction. More specifically, the motion prediction unit 111 performs motion prediction for generating a motion vector which indicates the regions that are similar to a current block in a predetermined searching range of a reference picture, the reference picture being encoded and then restored. The motion compensation unit 112 obtains data for the regions corresponding to the reference picture that is indicated by the generated motion vector and performs inter-prediction through a motion compensation process through which the prediction block of the current block is generated. In addition, the intra-prediction unit 113 performs intra-prediction by which the prediction block is generated using data for surrounding blocks that are adjacent to the current block. Here, inter-prediction and intra-prediction which were used in a conventional image compression standard such as the H.264 standard can be used or other various changed prediction methods can be used.

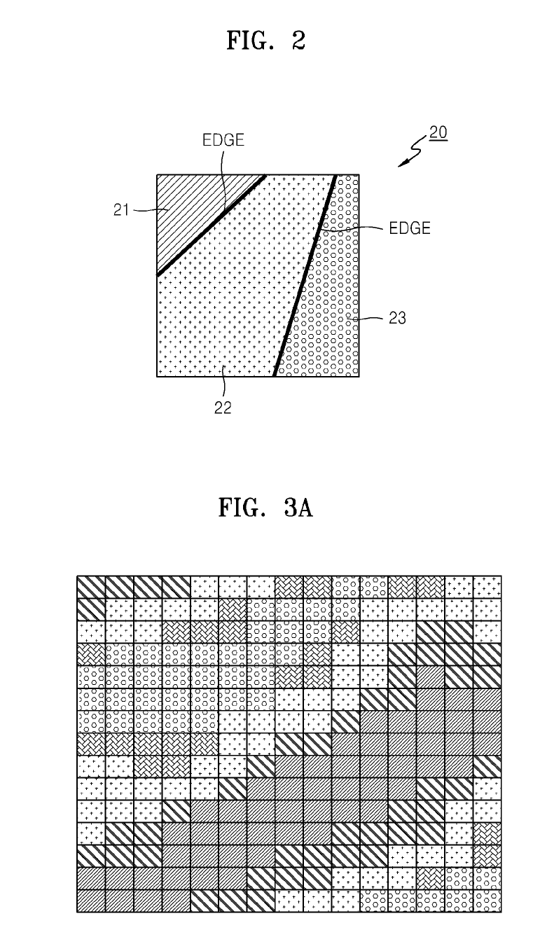

The dividing unit 115 divides the prediction block of the current block into a plurality of regions. More specifically, the prediction block is divided into a plurality of regions, wherein the prediction block is the regions of the reference picture that is searched as the most similar block to the current block in a predetermined searching range of the reference picture, the reference picture previously being encoded by the motion prediction unit 111 and the motion compensation unit 112. Hereinafter, dividing of the prediction block by the dividing unit 115 is described with reference to FIG. 2.

FIG. 2 is a reference view for explaining a dividing process performed on the prediction block, according to an exemplary embodiment of the present invention.

The dividing process according to an exemplary embodiment includes detecting edges existing in the prediction block and dividing the prediction block based on the detected edges.

Referring to FIG. 2, the dividing unit 115 detects the edges existing in a prediction block 20 of the reference picture determined through motion prediction and motion compensation using a predetermined edge detection algorithm and divides the prediction block 20 into a plurality of the regions 21, 22, and 23 based on the detected edges. Here, the edge detection algorithm may include various convolution masks such as a Sobel mask, a Prewitt mask, and a Laplacian mask or the edges can be detected by simply calculating a difference in pixel values between pixels that are adjacent to each other in the prediction block and detecting pixels that are different from adjacent pixels by a predetermined threshold value or more. In addition to this, various edge detection algorithms can be used and such edge detection algorithms are well known to those of ordinary skill in the art to which the present invention pertains. Thus, a more detailed description of the edge detection algorithms will be omitted here.

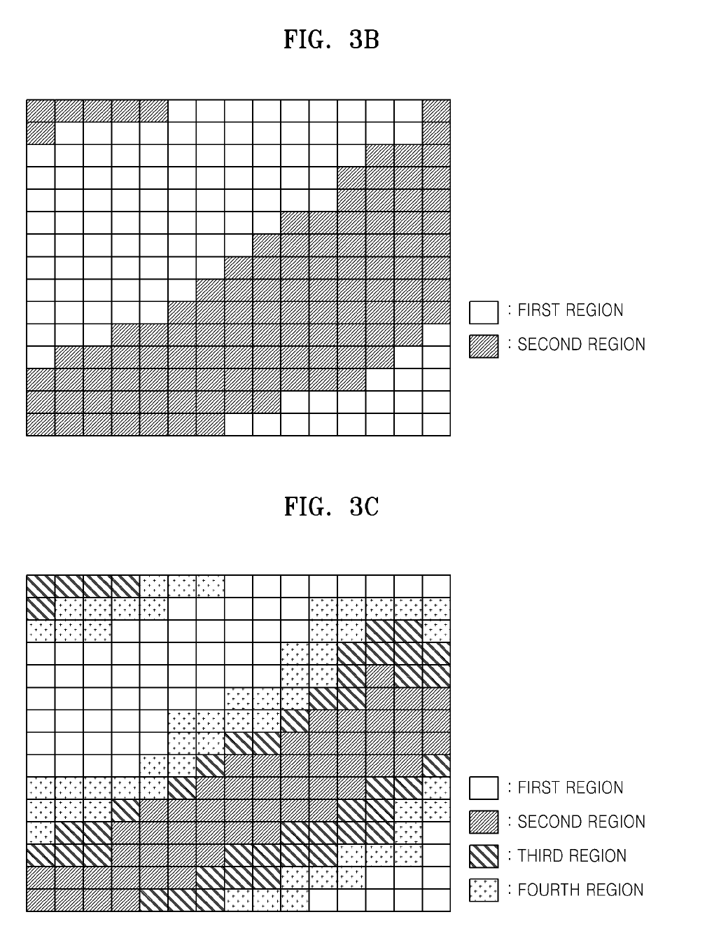

FIGS. 3A through 3C are reference views for explaining a dividing process performed on a prediction block, according to another exemplary embodiment of the present invention. Here, FIG. 3A illustrates an example of the prediction block of the current block, FIG. 3B illustrates that the prediction block is divided into two regions through vector quantization through which the pixel values of the pixels in the prediction block are quantized in two representative values, and FIG. 3C illustrates that the prediction block is divided into four regions by performing vector quantization whereby the pixel values of the pixels in the prediction block are quantized in four representative values.

Referring to FIGS. 3A through 3C, when the prediction block of the current block included in the reference block is determined by performing motion estimation on the current block, the dividing unit 115 considers the distribution of the pixel values of the pixels in the prediction block and determines a predetermined number of representative values. Then, the dividing unit 115 can divide the prediction block into a predetermined number of regions by performing vector quantization whereby the pixels that are different from each representative value by a predetermined threshold value or less are replaced with the representative values.

In addition, the dividing unit 115 can determine the number of regions to be divided in advance and then quantizes the pixels having similar pixel values from among the pixels included in the prediction block to be included in the same region, thereby dividing the prediction block. When each pixel of the prediction block as illustrated in FIG. 3A has a pixel value of 0 to N (N is a positive number) and it is determined in advance that the prediction block is divided into two regions, the dividing unit 115 can group pixels included in the prediction block having pixel values of 0 to (N/2−1) into a first region and can group pixels included in the prediction block having pixel values of (N/2) to (N−1) into a second region, as illustrated in FIG. 3B. Moreover, when the prediction block as illustrated in FIG. 3A is to be divided into four regions, the dividing unit 115 can group pixels included in the prediction block having pixel values of 0 to (N/4)−1, pixels included in the prediction block having pixel values of (N/4) to (N/2)−1, pixels included in the prediction block having pixel values of (N/2) to (N/4)−1, and pixels included in the prediction block having pixel values (N/4) to (N−1) into respectively a first region, a second region, a third region, and a fourth region, as illustrated in FIG. 3C. For example, when a pixel value of one pixel is represented as 8 bits, the pixel has the pixel values of 0 to 255. Here, when the dividing unit 115 is set to divide the prediction block into four regions, the dividing unit 115 divides the prediction block so as for the pixels having pixel values of 0 to 64 to be included in the first region, pixels having pixel values of 64 to 127 to be included in the second region, pixels having pixel values of 128-191 to be included in the third region, and pixels having pixel values of 192-255 to be included in the fourth region, from among the pixels included in the prediction block.

In addition to this, the dividing unit 115 can combine pixels that are similar to each other by applying various image dividing algorithms used in an image searching field such as MPEG-7 to divide the prediction block.

Referring back to FIG. 1, the compensation calculation unit 120 divides the current block into a plurality of regions, wherein the number and shape of the divided regions in the current block are to be the same as those in the divided prediction block, and calculates a difference between average values of the pixels included in the current block and the average values of the pixels correspond to those in the prediction block, for each region. More specifically, it is assumed that the prediction block is divided into m regions by the dividing unit 115, an i^{th} divided region in the prediction block denotes Pi (i is a positive number between 1 to m) and an i^{th} region in the current block corresponding to Pi from among the regions of the current block divided in a same manner as the prediction block denotes Ci. The compensation calculation unit 120 then calculates the average value mPi of the pixels included in the divided region Pi of the prediction block and the average value mCi of the pixels included in the divided region Ci of the current block. Then, the compensation calculation unit 120 calculates the difference of the average values in each region, that is, mPi-mCi. This difference value mPi-mCi (also referred to as “Di”) is used as a compensation value for compensating for the pixels in the i^{th} region of the prediction block. The prediction block compensation unit 130 adds the difference value Di calculated by each region to each pixel in the i^{th} region of the prediction block, thereby compensating for each region of the prediction block.

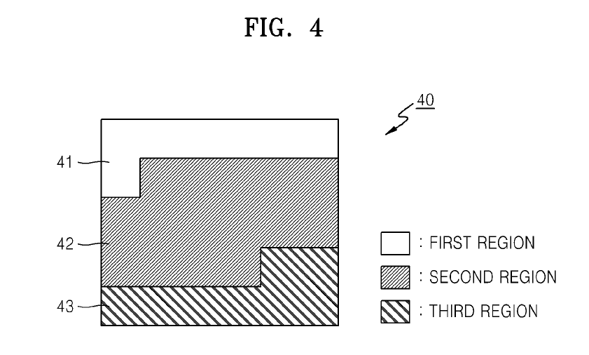

FIG. 4 is a reference view for explaining a process of calculating a compensation value in the compensation calculation unit 120 of FIG. 1 and a process of compensating each divided region of the prediction block in the prediction block compensation unit 130 of FIG. 1.

Referring to FIG. 4, it is assumed that a prediction block 40 is divided into three regions by the dividing unit 115. In this case, the compensation calculation unit 120 divides the current block in the same manner as the prediction block illustrated in FIG. 4. Then, the compensation calculation unit 120 calculates the average value, mP1, of the pixels included in a first region 41, the average value, mP2, of the pixels included in a second region 42, and the average value, mP3, of the pixels included in a third region 43. In addition, the compensation calculation unit 120 calculates the average values, mC1, mC2, and mC3, of the pixels included in the first through third regions of the current block that is divided in the same manner as the prediction block 40. Then, the compensation calculation unit 120 calculates compensation values, mP1-mC1, mP2-mC2, and mP3-mC3, of each region. When the compensation values of each region are calculated, the prediction block compensation unit 130 adds mP1-mC1 to each pixel of the first region 41, mP2-mC2 to each pixel of the second region 42, and mP3-mC3 to each pixel of the third region 43, thereby compensating for the prediction block 40.

Referring back to FIG. 1, the subtraction unit 140 generates a residual, which is a difference between the compensated prediction block and the current block.

The transformation and quantization unit 151 performs frequency transformation with respect to the residual and quantizes the transformed residual. As an example of the frequency transformation, Discrete Cosine Transformation (DCT) can be performed.

The entropy coding unit 152 performs variable length coding with respect to the quantized residual, thereby generating a bitstream. Here, the entropy coding unit 152 adds information regarding the compensation value used to compensate for each divided region of the prediction block to the bitstream generated as a result of the coding and information regarding the number of the regions divided in the prediction block to the bitstream. Since compensation is performed by dividing the prediction block into the predetermined number of regions in a decoding apparatus, in a similar manner as in an encoding apparatus, the compensated prediction block can be generated. In addition, the entropy coding unit 152 adds predetermined binary information indicating whether the current block is encoded using the compensated prediction block by each region according to an exemplary embodiment to header information of the encoded block so that the prediction block of the current block is divided in the decoding apparatus, thereby determining whether it is necessary to compensate. For example, when 1 bit indicating whether to apply the present invention is added to a bitstream and the result is ‘0,’ it means the block is encoded in the conventional way without compensation of the prediction block according to an exemplary embodiment of the present invention. When the result is ‘1,’ it means the block is encoded using the prediction block compensated through compensation of the prediction block according to an exemplary embodiment of the present invention.

The inverse-transformation and dequantization unit 160 performs dequantization and inverse-transformation with respect to the quantized residual signal so as to restore the residual signal. The addition unit 170 adds the restored residual signal and the compensated prediction block, thereby restoring the current block. The restored current block is stored in the storage unit 180 and is used to generate the prediction block of a next block.

In the apparatus for encoding an image according to an exemplary embodiment of the present invention, the prediction block is compensated using the difference between the average value of each region of the prediction block and the average value of each region of the current block. However, the present invention is not limited thereto. In addition to this, each region of the prediction block is transformed to the frequency domain, the difference between the pixel values of each region of the prediction block and the pixel values of each region of the current block is calculated based on frequency components other than Direct Current (DC) components, and the difference value can be used as the compensation value. Also, in order to simply transmit the compensation value during encoding, signs (+ and −) of the compensation values are firstly transmitted and information regarding the magnitude of the compensation value can be combined at a slice level or a sequence level and transmitted.

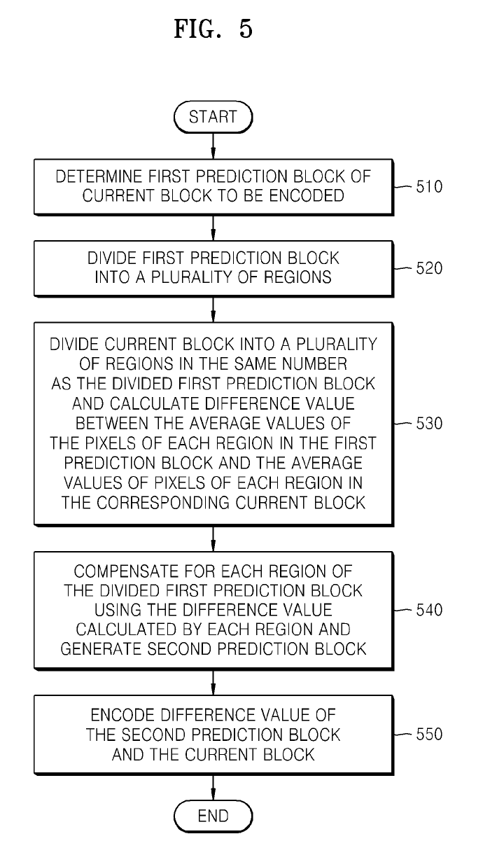

FIG. 5 is a flowchart illustrating a method of encoding an image, according to an exemplary embodiment of the present invention.

Referring to FIG. 5, a first prediction block of the current block to be encoded is determined in operation 510. Here, the first prediction block is distinguished from the compensated prediction block which will be described later and denotes the prediction block of the current block determined by performing general motion prediction.

In operation 520, the first prediction block is divided into a plurality of regions. As described above, the first prediction block is divided based on edges existing in the first prediction block or the first prediction block is divided into a plurality of regions through vector quantization, whereby pixels that are similar to each other from among the pixels existing in the first prediction block are included in the same region.

In operation 530, the current block is divided into a plurality of regions in a same manner with the divided first prediction block and a difference value between the average values of the pixels of each region in the first prediction block and the average values of pixels of each region in the corresponding current block are calculated.

In operation 540, each region of the divided first prediction block is compensated using the difference value calculated by each region and a second prediction block is generated from the compensated first prediction block.

In operation 550, a residual which is the difference value between the second prediction block and the current block is transformed, quantized, and entropy encoded to generate a bitstream. Here, according to an exemplary embodiment of the present invention, information regarding a predetermined prediction mode indicating whether each region of the prediction block is compensated or not, information regarding a compensation value by each region of the prediction block, and information regarding the number of the regions divided in the prediction block, are added to a predetermined region of the bitstream. When the number of regions divided in the prediction block is previously set in an encoder and a decoder, the information regarding the number of the regions is not added to the bitstream.

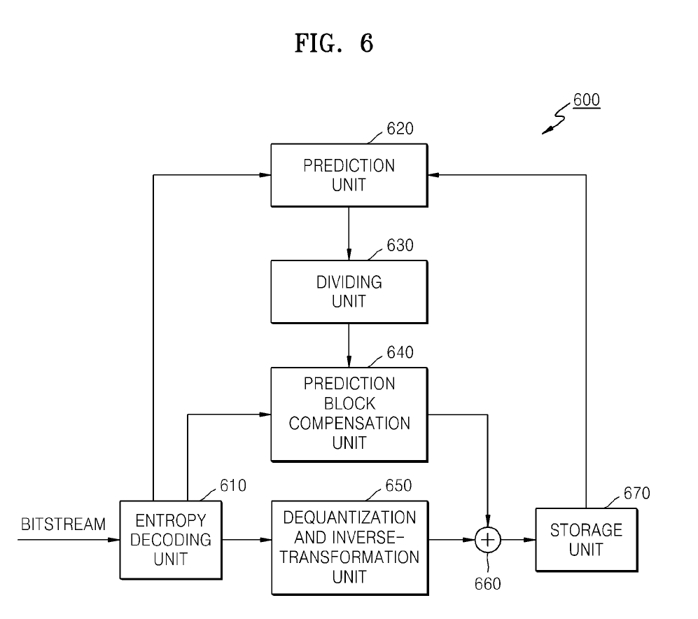

FIG. 6 is a block diagram of an apparatus for decoding an image, according to an exemplary embodiment of the present invention.

Referring to FIG. 6, an apparatus 600 for decoding an image includes an entropy decoding unit 610, a prediction unit 620, a dividing unit 630, a prediction block compensation unit 640, a dequantization and inverse-transformation unit 650, an addition unit 660, and a storage unit 670.

The entropy decoding unit 610 receives an input bitstream and performs entropy decoding, thereby extracting a prediction mode of the current block included in the bitstream, information regarding the number of regions obtained by dividing the prediction block of the current block, and information regarding compensation values. In addition, the entropy decoding unit 610 extracts a residual obtained by transforming and quantizing a difference value between the compensated prediction block of the current block and the input current block from the bitstream during encoding.

The dequantization and inverse-transformation unit 650 performs dequantization and inverse-transformation with respect to the residual of the current block, thereby restoring the residual.

The prediction unit 620 generates the prediction block with respect to the current block according to the extracted prediction mode. For example, when the current block is an intra predicted block, the prediction block of the current block is generated using data around the same frame that is previously restored. When the current block is an inter predicted block, the prediction block of the current block is obtained from a reference picture by using a motion vector included in the bitstream and reference picture information.

The dividing unit 630 divides the prediction block into a predetermined number of regions using extracted information regarding the number of the regions. Here, the dividing unit 630 operates in the same manner as the dividing unit 115 of FIG. 1, except that the information regarding the number of the regions included in the bitstream or information regarding the number of the regions that is previously set to be same in the encoder or decoder. Thus, a more detailed description thereof will be omitted here.

The prediction block compensation unit 640 adds the compensation values to the pixels of each region of the divided prediction block using the extracted values, thereby generating the compensated prediction block.

The addition unit 660 adds the compensated prediction block and the restored residual, thereby decoding the current block. The restored current block is stored in the storage unit and is used to decode a next block.

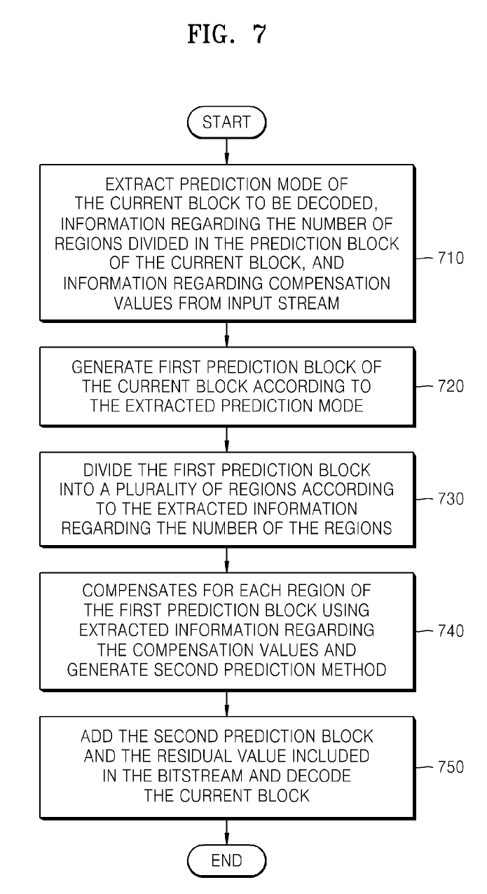

FIG. 7 is a flowchart illustrating a method of decoding an image, according to an exemplary embodiment of the present invention.

Referring to FIG. 7, a prediction mode of the current block to be decoded, information regarding the number of regions divided in the prediction block of the current block, and information regarding compensation values, are extracted from an input bitstream, in operation 710.

In operation 720, a first prediction block of the current block is generated according to the extracted prediction mode. Here, the first prediction block is distinguished from the compensated prediction block, and denotes the prediction block generated by performing general motion prediction.

In operation 730, the first prediction block is divided into a plurality of regions according to the extracted information regarding the number of regions.

In operation 740, a second prediction block, which is the compensated first prediction block in which each region of the first prediction block is compensated, is generated. More specifically, the compensation values calculated by each region of the divided first prediction block are added to pixels included in each region, thereby compensating for the average values of each region.

In operation 750, the second prediction block and the residual value included in the bitstream are added to decode the current block.

According to exemplary embodiments of the present invention, the prediction block is divided into a plurality of regions so as to perform compensation. Thus, errors between the current block and the prediction block are reduced and thereby prediction efficiency for an image can be increased. Accordingly, Peak Signal to Noise Ratio (PSNR) of an encoded image can be increased.

The invention can also be embodied as computer readable codes on a computer readable recording medium. The computer readable recording medium is any data storage device that can store data which can be thereafter read by a computer system. Examples of the computer readable recording medium include read-only-memory (ROM), random-access memory (RAM), CD-ROMs, magnetic tapes, floppy disks, and optical data storage devices.

In alternative exemplary embodiments of the present invention, the computer readable recording medium may include carrier waves (such as data transmission through the Internet). The computer readable recording medium can also be distributed over network coupled computer systems in exemplary embodiments of the present invention so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of encoding an image, the method comprising:
determining a first prediction block of a current block to be encoded;
dividing the determined first prediction block into a plurality of regions;
dividing the current block into a plurality of regions by a same number as in the divided first prediction block, and calculating a first difference value between an average value of pixels of each respective region of the first prediction block and an average value of pixels of a corresponding region of the current block;
compensating each region of the divided first prediction block by using the corresponding first difference value, and generating a second prediction block based on the compensated regions of the divided first prediction block; and
encoding a second difference value between the second prediction block and the current block.

2. The method of claim 1, wherein the determining of the first prediction block is performed through motion prediction and compensation which comprises searching for a most similar block to the current block in a predetermined region of a reference picture that is previously encoded.

3. The method of claim 1, wherein the dividing of the determined first prediction block into a plurality of regions is performed based on an edge detected from the first prediction block by using a predetermined edge detection algorithm.

4. The method of claim 1, wherein the dividing of the determined first prediction block into a plurality of regions is performed through vector quantization whereby pixels having similar pixel values from among the pixels included in the first prediction block are included in a same region.

5. The method of claim 1, wherein the generating of a second prediction block is performed by adding the first difference value, calculated by each respective region of the first prediction block and corresponding current block, to each pixel included in the corresponding region of the first prediction block to compensate the average values of the pixels of each region in the first prediction block.

6. The method of claim 1, wherein the method further comprises adding information regarding the number of the regions divided in the first prediction block to a bitstream generated as a result of the encoding of the image.

7. The method of claim 1, wherein the method further comprises adding information regarding the first difference value between the average value of the pixels of each respective region of the first prediction block and the average value of the pixels of each corresponding region in the current block to a bitstream generated as a result of the encoding of the image.

8. An apparatus for encoding an image, the apparatus comprising:
a prediction unit which determines a first prediction block of a current block to be encoded;
a dividing unit which divides the determined first prediction block into a plurality of regions;
a compensation calculation unit which divides the current block into a plurality of regions by a same number as in the divided first prediction block, and calculates a first difference value between an average value of pixels of each respective region of the first prediction block and an average value of pixels of a corresponding region of the current block;
a prediction block compensation unit which compensates each region of the divided first prediction block by using the corresponding first difference value, and generating a second prediction block based on the compensated regions of the divided first prediction block; and
an encoding unit which encodes a second difference value between the second prediction block and the current block.

9. The apparatus of claim 8, wherein the prediction unit determines the first prediction block by performing motion prediction and compensation which comprises searching for a most similar block to the current block in a predetermined region of a reference picture that is previously encoded.

10. The apparatus of claim 8, wherein the dividing unit divides the first prediction block based on an edge detected from the first prediction block by using a predetermined edge detection algorithm.

11. The apparatus of claim 8, wherein the dividing unit divides the first prediction block by performing vector quantization whereby pixels having similar pixel values from among the pixels included in the first prediction block are included in a same region.

12. The apparatus of claim 8, wherein the prediction block compensation unit compensates the average value of the pixels of each region in the first prediction block by adding the first difference value, calculated by each respective region of the first prediction block and corresponding current block, to each pixel included in the corresponding region of the first prediction block.

13. The apparatus of claim 8, wherein the encoding unit adds information regarding the number of the regions divided in the first prediction block to a bitstream generated as a result of the encoding of the image.

14. The apparatus of claim 8, wherein the encoding unit adds information regarding the first difference value between the average value of the pixels of each respective region of the first prediction block and the average value of the pixels of each corresponding region in the current block to a bitstream generated as a result of the encoding of the image.

15. A method of decoding an image, the method comprising:
extracting a prediction mode of a current block to be decoded, information regarding a number of divided regions in a prediction block of the current block, and information regarding compensation values, from an input bitstream;
generating a first prediction block of the current block according to the extracted prediction mode;
dividing the first prediction block into a plurality of regions according to the extracted information regarding the number of the divided regions;
compensating each region of the divided first prediction block by using the extracted information regarding the compensation values, and generating a second prediction block based on the compensated regions of the divided first prediction block; and
adding the second prediction block to a residual value included in the bitstream, to decode the current block.

16. The method of claim 15, wherein the generating of the first prediction block is performed through motion compensation which comprises searching for a most similar block to the current block in a predetermined region of a reference picture that is previously encoded using motion vector of the current block included in the bitstream.

17. The method of claim 15, wherein the dividing of the first prediction block into a plurality of regions is performed based on an edge detected from the first prediction block by using a predetermined edge detection algorithm.

18. The method of claim 15, wherein the dividing of the first prediction block into a plurality of regions is performed through vector quantization whereby pixels having similar pixel values from among pixels included in the first prediction block are to be included in a same region.

19. The method of claim 15, wherein the generating the second prediction block is performed by adding a respective compensation value determined from the extracted information regarding compensation values to each pixel included in each region of the first prediction block, to compensate for average values of pixels of each region in the first prediction block.

20. An apparatus for decoding an image, the apparatus comprising:
an entropy decoding unit which extracts a prediction mode of a current block to be decoded, information regarding a number of divided regions in a prediction block of the current block, and information regarding compensation values, from an input bitstream;
a prediction unit which generates a first prediction block of the current block according to the extracted prediction mode;
a dividing unit which divides the first prediction block into a plurality of regions according to the extracted information regarding the number of the divided regions;
a compensation unit which compensates each region of the divided first prediction block by using the extracted information regarding the compensation values, and generating a second prediction block based on the compensated regions of the divided first prediction block; and
an addition unit which adds the second prediction block to a residual value included in the bitstream, to decode the current block.

21. The apparatus of claim 20, wherein the prediction unit generates the first prediction block through motion compensation which comprises searching for a most similar block to the current block in a predetermined region of a reference picture that is previously encoded using a motion vector of the current block included in the bitstream.

22. The apparatus of claim 20, wherein the dividing unit divides the first prediction block based on an edge detected from the first prediction block by using a predetermined edge detection algorithm.

23. The apparatus of claim 20, wherein the dividing unit divides the first prediction block through vector quantization whereby pixels having similar pixel values from among pixels included in the first prediction block are included in a same region.

24. The apparatus of claim 20, wherein the compensation unit adds a respective compensation value determined from the extracted information regarding compensation values to each pixel included in each region of the first prediction block, to compensate for average values of pixels of each region in the first prediction block.
